(19) United States
(12) Patent Application Publication
(10) Pub. No.: US 2003/0052881 A1
(43) Pub. Date: Mar. 20, 2003

(54) Graphical value display program, graphical value display method and recording medium

(75) Inventor: Shigeru Otagiri, Nagano (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/093,489

(22) Filed: Mar. 11, 2002

(30) Foreign Application Priority Data
Sep. 19, 2001 (JP) 2001-285266

(51) Int. Cl. G06T 11/20

(52) U.S. Cl. 345/440

(57) ABSTRACT

A graphical value display program, a graphical value display method and a recording medium for displaying a value on a graph are disclosed. A virtual graph having an arbitrary graduation is generated and displayed in superposition on a graph such as a data sheet. The numerical values of vertical and horizontal coordinates are displayed when the cursor is located at an arbitrary position or comes to a position over the original graph, thereby making it possible to read an arbitrary point on the original graph both easily and accurately. The program causes a computer to execute the steps of reading and displaying the original graph, generating a virtual graph having a starting point, an ending point and a graduation corresponding to a starting point, an ending point and a graduation, respectively, designated or input on the displayed original graph, displaying the generated virtual graph in superposition on the original graph, and displaying the coordinates of the cursor position in response to the movement of the cursor or a designation on the virtual graph displayed in superposition.

### BACKGROUND OF THE INVENTION

1. Field of the Invention

The present invention relates to a graphical value display program, a graphical value display method and a recording medium for displaying a graphical value.

2. Description of the Related Art

In the prior art, the information on the characteristics of electronic parts, called data sheets are prepared by semiconductor makers and electronic parts makers, and designers use the particular parts for design with reference to the characteristic graphs on the data sheet. In the process, the vertical or horizontal numerical values (characteristics values) at a desired point of the characteristics graph on the data sheet displayed on the screen are not easy to identify. Therefore, a line segment is printed on the paper using a ruler to read the vertical and horizontal numerical values more accurately.

As described above, the characteristic graphs drawn on the data sheet used in the prior art poses the problem that the vertical and horizontal numerical values on the screen cannot be accurately read, and it is necessary to take the trouble of printing them on the paper to read the numerical values accurately.

### SUMMARY OF THE INVENTION

In order to obviate this problem, the object of the present invention is to provide a graphical value display program, a graphical value display method and a recording medium, in which a virtual graph having an arbitrary graduation is generated based on a graph such as a data sheet and displayed in superposition, and when the cursor is placed at an arbitrary point or positioned on the original graph, the vertical and horizontal numerical values are displayed, thereby making it possible to read the numerical values of an arbitrary point on the original graph both easily and accurately.

Means for solving this problem will be explained with reference to FIG. 1.

In FIG. 1, a processing unit 1 is for performing various processes in accordance with a program, and in the case under consideration, is configured of image data reading means 4 and image graphical numerical value calculation means 5.

The image data reading means 4 is for reading image data.

The image graphical numerical value calculation means 5 is for calculating the values at an arbitrary point on the graph, and in this case, configured of virtual graph generating means 6 and value generating means 7.

The virtual graph generating means 6 is for generating a virtual graph having a starting point, an ending point and a graduation based on and in accordance with an input or designation of the starting point, the ending point and the graduation on the original graph, respectively.

The value generating means 7 is for generating the coordinates of a cursor position in response to the movement of the cursor or designation on the virtual graph displayed in superposition.

Now, the operation will be explained.

The image data reading means 4 reads and displays the image data of the graph. The virtual graph generating means 6 generates a virtual graph having a starting point, an ending point and a graduation based on and corresponding to the designation or input of a starting point, an ending point and the graduation, respectively, on the original graph on display, and displays the generated virtual graph in superposition. The value generating means 7 generates and displays the coordinates of the cursor position in response to the cursor movement or designation on the virtual graph displayed in superposition.

The coordinates of the cursor position are displayed in such a manner that the cursor is moved on the virtual graph and when the cursor reaches a position on the original graph on which the virtual graph is displayed in superposition, the coordinates of the corresponding position on the virtual graph are displayed.

Also, when the cursor reaches a position on the original graph on which the virtual graph is displayed in superposition and the particular position is other than a vertical or horizontal line longer than a predetermined length on the original graph, the coordinates of the corresponding position on the virtual graph are displayed.

Further, the coordinates of the cursor position displayed are stored, and displayed or printed as a list.

Thus, in the case where a virtual graph having an arbitrary graduation is generated and displayed in superposition on a graph such as a data sheet, with the cursor set in an arbitrary position or over the original graph, the vertical and horizontal numerical values (coordinates) are displayed. In this way, an arbitrary point on the original graph can be easily and accurately read as numerical values.

### BRIEF DESCRIPTION OF THE DRAWINGS

FIGS. 1A and 1B are diagrams showing a system configuration according to the invention.

FIGS. 2A and 2B are flowcharts for explaining the operation of the invention.

FIGS. 3A and 3B show a first display example of the invention.

FIGS. 4A and 4B show a second display example of the invention.

FIG. 5 shows a third display example of the invention.

FIG. 6 is a flowchart for explaining the other operation of the invention.

### DESCRIPTION OF THE PREFERRED EMBODIMENTS

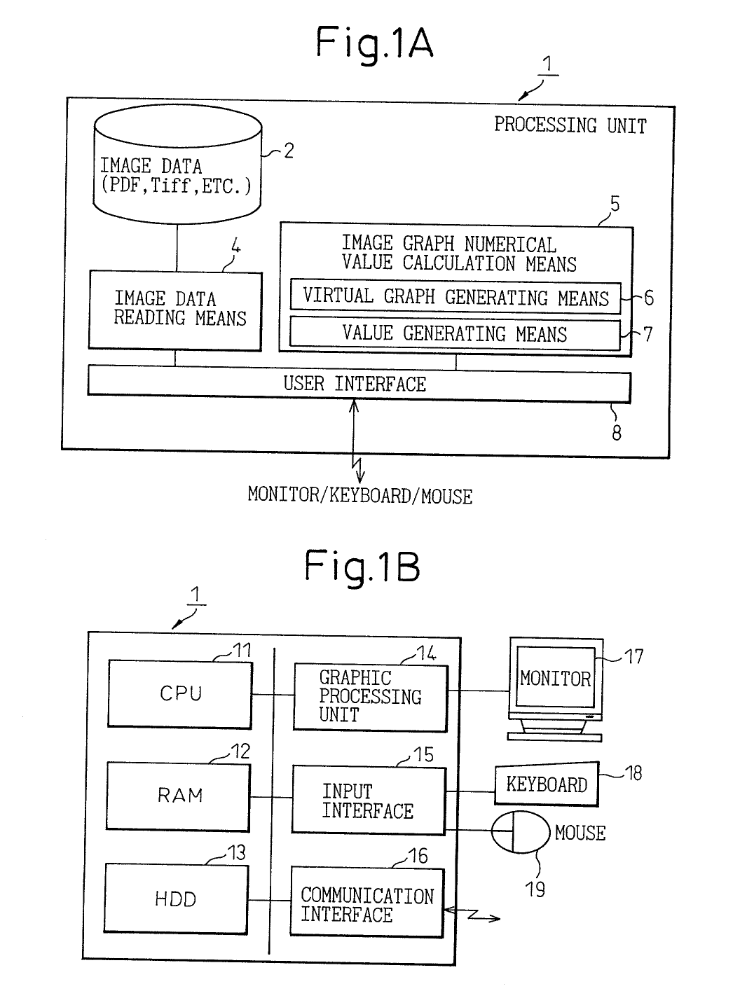

Now, an embodiment of the present invention and the operation thereof will be sequentially described in detail with reference to FIGS. 1 to 6.

A system configuration of the invention is shown in FIG. 1.

FIG. 1A is a diagram showing a system configuration, and FIG. 1B a diagram showing a hardware configuration.

In FIG. 1A, a processing unit 1 is for performing various processes in accordance with a program, and includes image data 2, an image data reading means 4, an image graphical numerical value calculation means 5 and a user interface 8.

The image data 2 are those of the graph plotted in the data sheet, etc. which are stored in a hard disk unit or the like.

The image data reading means 4 is for reading the image data 2.

The image graphical numerical value calculation means 5 is for calculating the value at an arbitrary point on a graph, and includes a virtual graph generating means 6 and a value generating means 7.

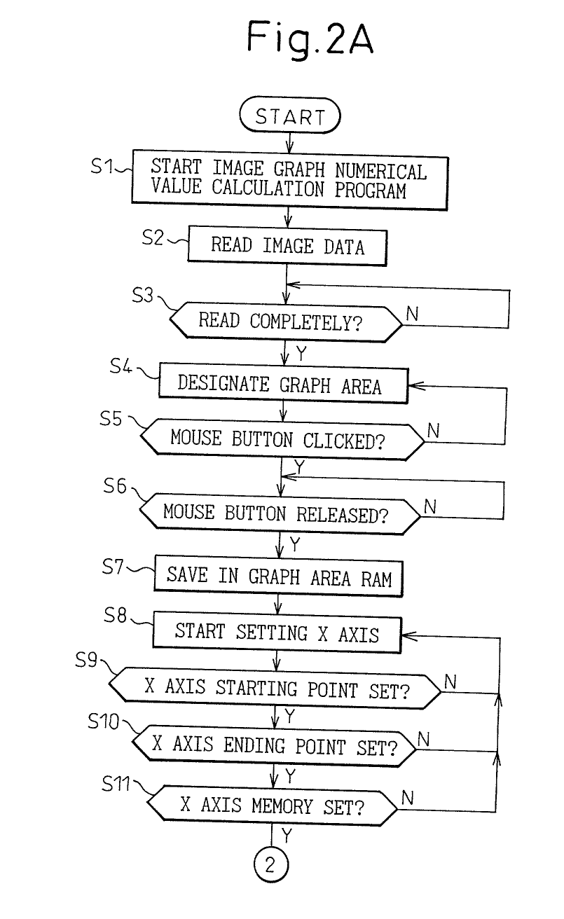

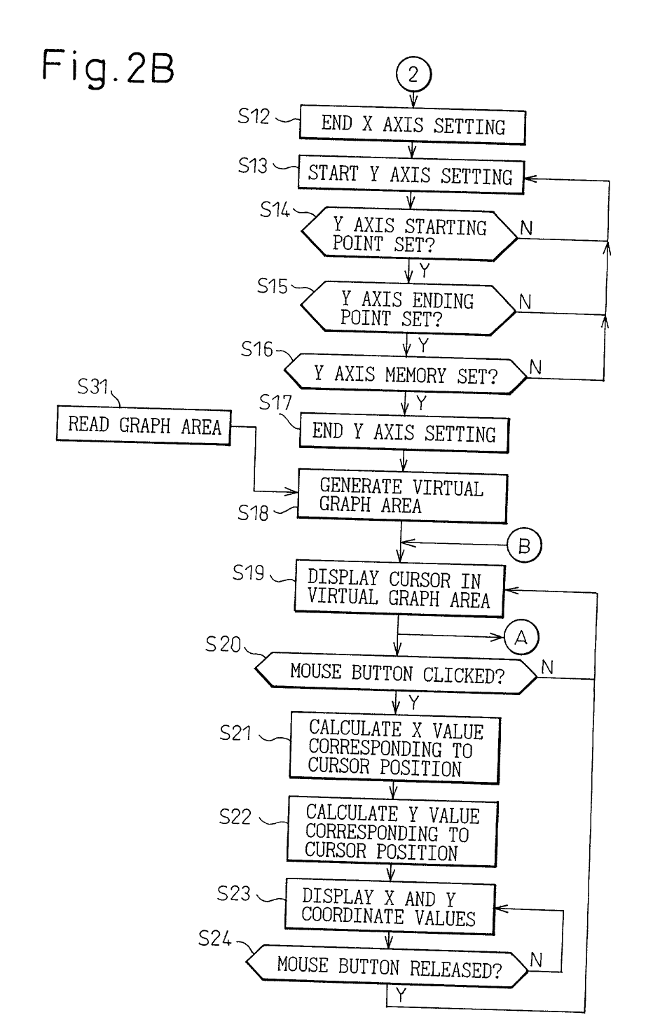

The virtual graph generating means 6 is for generating a virtual graph having a starting point, an ending point and a graduation based on and in accordance with the designation or input of a starting point, an ending point or a graduation, respectively, on the original graph (described later with reference to FIGS. 2 to 6).

The value generating means 7 is for generating the coordinates of the cursor position in response to the cursor movement or designation on the virtual graph displayed in superposition (described later with reference to FIGS. 2 to 6).

The user interface 8 is for performing various operations and giving various instructions in dialogues with the user. For example, a message is displayed on the screen, not shown (the screen of the monitor 17 shown in FIG. 1B), and the user processes the message by operating the keyboard 18 and the mouse 19 in response to various instructions (to designate the starting and ending points of the virtual graph with the mouse or inputting the size of the scale divisions through the keyboard).

FIG. 1B shows an example of a hardware system configuration required for the processing unit 1 to execute various processes in accordance with a program.

In FIG. 1B, the processing unit 1 is configured of hardware units 11 to 16.

A CPU 11 is for executing various processes in accordance with a program.

A RAM 12 is a random-access memory for developing a program and storing data.

A HDD 13 is a large-capacity storage unit which is a hard disk drive in this case.

A graphic processing unit 14 is for displaying various graphs on the monitor 17.

An input interface 15 is for retrieving the data input from the keyboard 18 and the mouse 19.

A communication interface 16 is for transmitting and receiving data to and from the processing unit 1 and other devices not shown.

A monitor 17 is for displaying various data. In the case under consideration, a graph and a virtual graph are displayed in superposition on each other.

A keyboard 18 and a mouse 19 are for inputting various instructions and data.

Now, the operation performed with the configuration shown in FIG. 1 will be explained in detail with reference to each step shown in the flowcharts of FIGS. 2A and 2B.

The flowchart of FIGS. 2A and 2B are for explaining the operation according to this invention.

In FIGS. 2A and 2B, an image graphical numerical value calculation program is started in step S1. In this step, the image graphical numerical value calculation means 5 shown in FIG. 1A is operated by starting the image graphical numerical value calculation program.

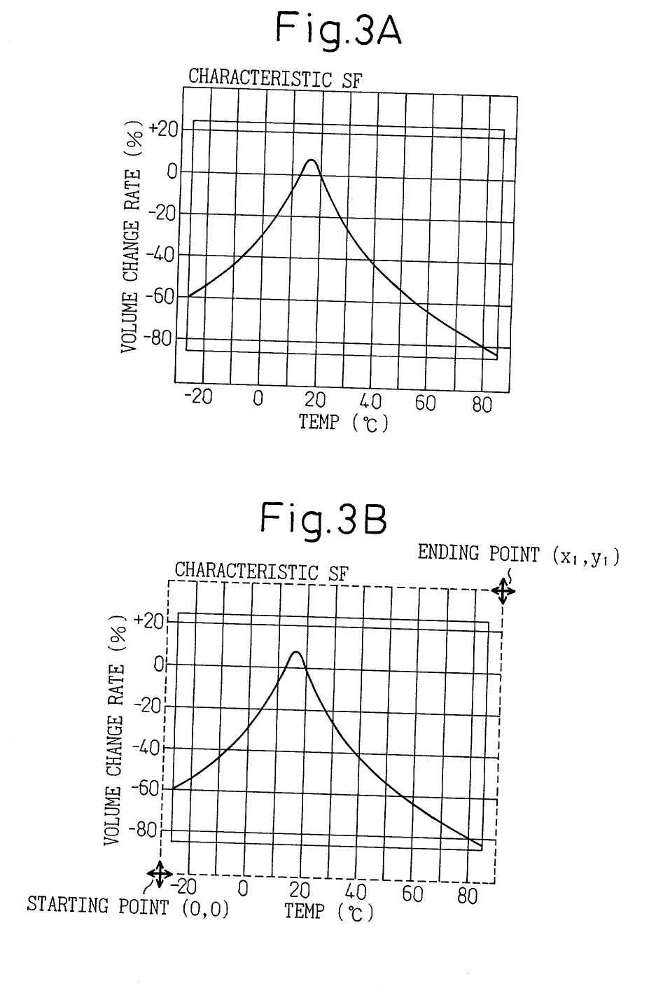

In step S2, the image data are read. Specifically, the image data 2 of the graph designated on the data sheet (the image data of the graph of FIG. 3A described later, for example) are read from an external storage unit by the image data reading means 4 shown in FIG. 1(a).

In step S3, it is determined whether the read operation is complete or not. In the case where the answer is YES, the process proceeds to step S4. In the case where the answer is NO, on the other hand, the process of step S2 is repeated.

Step S4 is for designating a graph area.

In step S5, it is determined whether the mouse button has been clicked or not. In the case where the answer is YES, the process proceeds to step S6, otherwise the process of step S4 is repeated.

In step S6, it is determined whether the mouse button is released or not. In the case where the answer is YES, the process proceeds to step S7, otherwise the process of step S6 is repeated.

In step S7, the process is saved in the graph area RAM.

In the process of steps S2 to S7, the starting point (0, 0) and the ending point (x₁, y₁) for generating a virtual graph on the original graph in FIG. 3B are designated, and the coordinate values thereof are saved in the graph area RAM.

In step S8, the setting of the X axis is started.

In step S9, it is determined whether the starting point of the X axis has been set or not. In the case where the answer is YES, the process proceeds to step S10. In the case where the answer is NO, step S9 is repeated.

In step S10, it is determined whether the ending point of the X axis has been set or not. In the case where the answer is YES, the process proceeds to step S11. Otherwise, step S10 is repeated.

In step S11, it is determined whether the graduation along the X axis has been set or not. In the case where the answer is YES, the process proceeds to step S12, otherwise step S11 is repeated.

In step S12, the setting of the X axis is completed.

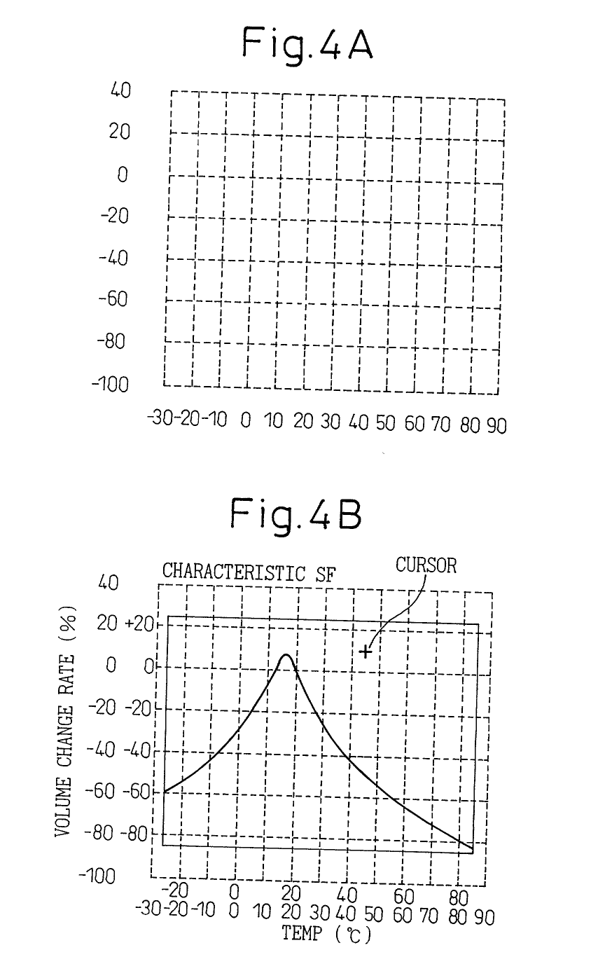

Through the process of steps S8 to S12 described above, the graduation of the virtual graph along the X axis can be set, as shown in FIG. 4(C), based on the staring point (0, 0), the ending point (x₁, y₁) and the scale divisions designated on the graph of FIG. 3B.

In step S13, the setting along the Y axis is started.

In step S14, it is determined whether the starting point along the Y axis has been set or not. In the case where the answer is YES, the process proceeds to step S15, otherwise the process of step S14 is repeated.

In step S15, it is determined whether the ending point along the Y axis has been set or not. In the case where the answer is YES, the process proceeds to step S16. In the case where the answer is NO, the process of step S15 is repeated.

In step S16, it is determined whether the graduation along the Y axis has been set or not. In the case where the answer is YES, the process proceeds to step S17, otherwise step S16 is repeated.

In step S17, the setting along the Y axis is completed.

Through the process of steps S13 to S17 described above, the graduation of the virtual graph along the Y axis can be set, as shown in FIG. 4A, based on the staring point (0, 0), the ending point (x₁, y₁) and the scale divisions designated on the graph of FIG. 3B.

In step S18, a virtual graph area is generated. In step S31, the graph area is read thereby to generate the virtual graph area.

In step S19, the cursor is displayed in the virtual graph area (FIG. 4A), which, in turn, is displayed in superposition on the original graph as shown in FIG. 4B and described later.

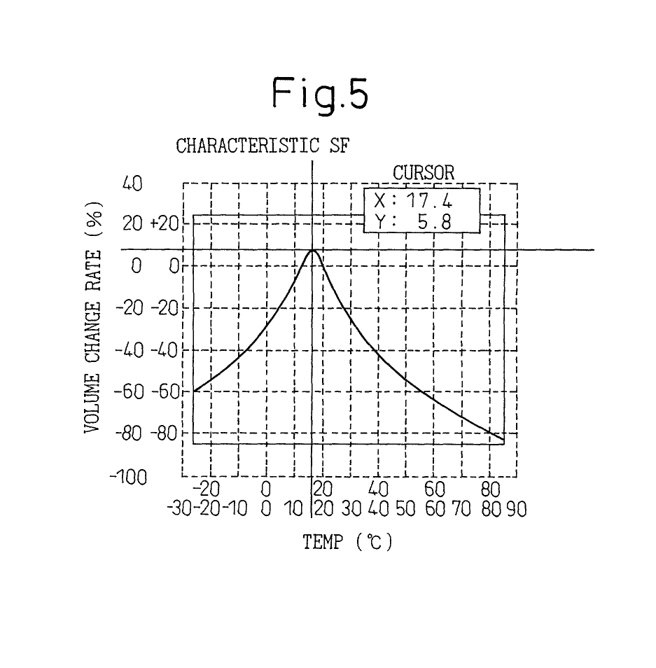

In step S20, it is determined whether the mouse button has been clicked or not, for example, in the state of FIG. 5 described later. In the case where the answer is YES, the process proceeds to step S21, otherwise step S19 is repeated.

In step S21, the value along the X axis corresponding to the cursor position is calculated.

In step S22, the value along the Y axis corresponding to the cursor position is calculated.

In step S23, the X and Y coordinate values are displayed. Through the process of these steps including step S20 where the answer is YES, steps S21, S22 and S23, as shown in FIG. 5, upon clicking of the mouse button with the cursor located at the shown position on the virtual graph, the X and Y coordinates of the cursor position on the virtual graph are calculated, and these values of the X and Y coordinates are displayed in the upper right window.

In step S24, it is determined whether the mouse button has been released or not. In the case where the answer is YES, the process returns to step S19, which is repeated. In the case where the answer is NO, the process returns to step S23, where the process waits while displaying the X and Y coordinate values in the window.

Through the process of steps S19 to S24 described above, as shown in FIG. 5, upon clicking of the mouse with the cursor of the virtual graph located at an arbitrary point on the original graph displayed in superposition, the prevailing X and Y coordinates of the cursor are displayed in the small window. Thus, the numerical values (X coordinate, Y coordinate) indicated by the cursor on the original graph can be displayed and read accurately. These numerical values disappear when the mouse button is released. This applies equally to other points, where the numerical values of the X and Y coordinates representing the accurate cursor position can be displayed both easily and rapidly.

Also, the X and Y coordinate values displayed in the window by clicking the mouse button can be stored, and upon depression of a list print button, not shown, a list of the X and Y coordinate values stored can be printed.

FIGS. 3 to 5 show examples of graphs displayed according to the invention.

FIG. 3A shows an example of a graph. This example graph indicates the characteristics of a component part of a product being developed by an electrical engineer. In this data sheet graph, the abscissa represents the temperature in ° C., and the ordinate the volume change rate in %. The intention of this example is to accurately read the X coordinate value (temperature) and the Y coordinate value (volume change rate) at an arbitrary point on this graph.

FIG. 3B schematically shows the manner in which the starting point (0, 0) and the ending point (x₁, y₁) are designated by mouse for generating a virtual graph on the graph of FIG. 3(A). As shown in FIG. 3B, the graph of FIG. 3(A) is displayed, and the starting point (0, 0), the ending point (x₁, y₁) and the scale division of the virtual graph to be generated are designated on the graph of FIG. 3A (steps S4 to S7 in FIG. 2 described above). The designation is made, for example, as

X axis: (−30, 90, 10)

Y axis: (−100, 40, 20)

In this designation, “−30” for X axis indicates the graduation of the starting point, “90” the graduation of the ending point, and “20” the scale division. As a result, as shown by the X axis in FIG. 4A described later, a virtual graph along X axis extending from the starting point −30 to the ending point 90 is designated with the scale division of 10. This is also the case with the Y axis. As shown by the Y axis in FIG. 4A, a virtual graph along Y axis extending from the starting point −100 to the ending point 40 is designated with the scale division of 20.

FIG. 4A shows an example of a virtual graph. This virtual graph is generated based on the following designation in FIG. 3(B):

X axis: (−30, 90, 10)

Y axis: (−100, 40, 20).

FIG. 4B shows an example in which the graph of FIG. 3(A) and the virtual graph of FIG. 4(C) are displayed in superposed relation with each other. The cursor is displayed on the virtual graph.

FIG. 5 shows an example of the numerical values displayed. The cursor is moved to the shown position on the original graph in FIG. 4B and depressed. The numerical values of the X and Y coordinates representing the cursor position on the virtual graph are displayed in a small window at the upper right portion, as follows:

X: 17, 4

Y: 5, 8

In this way, by locating the cursor at a position on the virtual graph corresponding to an arbitrary position of the original graph, the numerical values of the X and Y coordinates of the position on the original graph can be accurately and easily displayed and can be read in a small window.

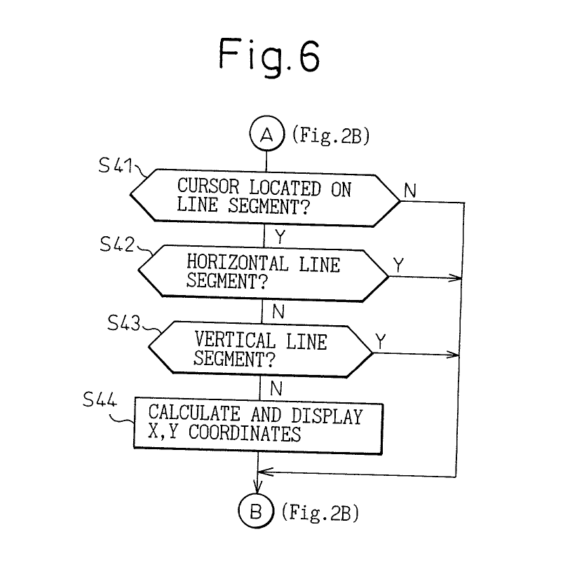

FIG. 6 is a flowchart for explaining the other process of the operation according to the invention. The flowchart of FIG. 6 starts with the access at point A in FIG. 2 and ends by returning to point B in FIG. 2. This flowchart is intended to automatically display, in a small window, the numerical values of the X and Y coordinates of the cursor, in the case where the cursor on the virtual graph of FIG. 5 is located on a curve in the original graph. This makes it possible to accurately display the X and Y coordinates of the position of a curve on the original graph.

In FIG. 6, S41 is a step for determining whether the cursor is located on a line segment or not. Specifically, it is determined whether the cursor on the virtual graph is located or not on a line segment in the original graph in FIG. 5. In the case where the answer is YES, the process proceeds to step S42, while if the answer is NO, step S41 is repeated.

In step S42, it is determined whether there is a horizontal line segment or not. This step S42 is to further determine, based on the determination in S41 that the cursor is located on a line segment in the graph of FIG. 5, whether the cursor is located on a line segment horizontally longer than a predetermined graduation length. In the case where the answer is YES, it indicates that the cursor is located on a line segment horizontally longer than a predetermined graduation length, and therefore the process is terminated. In the case where the answer is NO, on the other hand, it indicates that the cursor is not located on a line segment horizontally longer than a predetermined graduation length (that is to say, the line segment is not the graduation line), and therefore the process proceeds to step S43.

In step S43, it is determined whether there is a line segment in the vertical direction or not. In view of the affirmative answer in step S41 indicating that the cursor is located on a line segment in the graph of FIG. 5 and the negative answer in step S42 indicating that the cursor is not located on a line segment horizontally longer than a predetermined graduation length (that is to say, the line segment is not the graduation line), it is determined further whether the cursor is located on a line segment vertically longer than a predetermined graduation length. In the case where the answer is YES, it indicates that the cursor is located on a line segment vertically longer than a predetermined graduation length, and therefore the process is terminated. In the case where the answer in step S43 is NO, on the other hand, it indicates that the cursor is not located on a line segment vertically longer than a predetermined graduation length, but only on a line segment (curve) on the original graph, and therefore the process proceeds to step S44.

In step S44, the X and Y coordinates are calculated and displayed. Thus, as shown in the small window of FIG. 5 described above, the X and Y coordinates of the cursor can be calculated and displayed only in the case where the cursor is located on a line segment (curve) of the original graph. As a result, when the cursor is moved arbitrarily and comes to be located on a line segment (curve) of the graph on the screen of FIG. 5, the values of the X and Y coordinates of the particular position can be automatically displayed in the small window.

In the case where a line segment is longer than a predetermined graduation length in a horizontal or the vertical direction, it is determined that the cursor is not located on a line segment (curve) of the original graph, as described above. Nevertheless, a dotted line, one-dot chain or a two-dot chain constituting the graduation line of the virtual graph which is longer than a predetermined length is neither determined as a line segment (curve) of the original graph.

It will thus be understood from the foregoing description that according to this invention, a virtual graph having an arbitrary graduation is generated based on an original graph such as a data sheet and displayed in superposition on the particular original graph, and in the case where the cursor is located at an arbitrary position or on a line, the numerical values (coordinates) along X and Y axes are displayed. Thus, an arbitrary point on a graph can be easily and accurately read as numerical values.

1. A graphical value display program to be executed by a computer, comprising the steps of:
reading and displaying an original graph;
generating a virtual graph having a starting point, an ending point and a graduation corresponding to the designation or input of a starting point, an ending point and a graduation, respectively, of said displayed original graph;
displaying said generated virtual graph in superposition on said original graph; and
displaying the coordinates of the position of a cursor moved or designated on said virtual graph displayed in superposition on said original graph.

2. A graphical value display program to be executed by a computer according to claim 1, further comprising the step of:
displaying the coordinates of the position of said cursor on the virtual graph in the case where said cursor is moved on said virtual graph and comes to be located at a position over said original graph on which said virtual graph is superposed.

3. A graphical value display program according to claim 2, further comprising the step of:
displaying the coordinates of the position of said cursor on the virtual graph in the case where said cursor comes to be located over other than a vertical or a horizontal line longer than a predetermined length at a position in said original graph on which said virtual graph is superposed.

4. A graphical value display program to be executed by a computer according to claim 1, further comprising the step of:
storing said displayed coordinates of the cursor position and displaying or printing said coordinates as a list.

5. A graphical value display method comprising the steps of:
reading and displaying an original graph;
generating a virtual graph having a starting point, an ending point and a graduation corresponding to the designation or input of a starting point, an ending point and a graduation, respectively, of said displayed original graph;
displaying said generated virtual graph in superposition on said original graph; and
displaying the coordinates of the position of a cursor moved or designated on said virtual graph displayed in superposition on said original graph.

6. A computer-readable recording medium for recording a program for executing the steps of:
reading and displaying an original graph;
generating a virtual graph having a starting point, an ending point and a graduation corresponding to the designation or input of a starting point, an ending point and a graduation, respectively, of said displayed original graph;
displaying said generated virtual graph in superposition on said original graph; and
displaying the coordinates of the position of a cursor moved or designated on said virtual graph displayed in superposition on said original graph.
